(19) United States
(12) Patent Application Publication
(10) Pub. No.: US 2011/0057614 A1
(43) Pub. Date: Mar. 10, 2011

(54) Power Supply Adapter

(76) Inventor: Eng Choon Low, Mongkok (HK)

(21) Appl. No.: 12/840,930

(22) Filed: Jul. 21, 2010

Related U.S. Application Data
(63) Continuation-in-part of application No. PCT/GB2010/050745, filed on May 7, 2010.

(30) Foreign Application Priority Data
Jul. 21, 2009 (GB) 0912618.6
Aug. 28, 2009 (GB) 0914991.5

(51) Int. Cl. H02J 7/02; H01R 13/66

(52) U.S. Cl. 320/111; 439/620.01

(57) ABSTRACT

A portable power supply adapter includes a casing and a mains power supply cable extending from the casing for connection to a mains power supply. A portable computer power supply cable extends from the casing for connection to a portable computer. The casing includes power supply circuitry. The casing has an upwardly facing surface, the surface including a plurality of sockets, each adapted to receive a portable electric device and arranged so that a plurality of portable electric devices may be charged from the mains power supply directly whether or not a portable computer is connected to the portable computer power supply cable for charging.

### CROSS REFERECE TO RELATED APPLICATIONS

This application claims priority to the following applications: United Kingdom Application No. 0912618.6 filed on Jul. 21, 2009; United Kingdom Application No. 0914991.5 filed on Aug. 28, 2009; and WIPO Application No. PCT/GB2010/050745 filed on May 7, 2010. The disclosures of each of these three applications are hereby incorporated by reference in their entirety.

### BACKGROUND OF THE INVENTION

This invention relates to a power supply adapter for portable electric devices. Portable electric devices such as entertainment and storage devices, phones or computers have a variety of electrical connectors with corresponding power and data cables so that it is necessary to carry a corresponding number of power supplies and data cables, particularly when travelling. It is often the case that only one device may be charged at a time from a single power supply socket, particularly if one is using an international socket adapter in a foreign country.

### SUMMARY OF THE INVENTION

According to a first aspect of the present invention, a portable power supply adapter includes a casing and a mains power supply cable extending from the casing for connection to a mains power supply. A portable computer power supply cable extends from the casing for connection to a portable computer. The casing includes power supply circuitry. The casing has an upwardly facing surface, the surface including one or more sockets, the sockets being adapted to receive a portable electric device and arranged so that the portable electric device may be charged from the mains power supply directly whether or not a portable computer is connected to the portable computer power supply cable for charging.

The power supply may be a mains power supply or a low voltage power supply from another device. A data transfer connection may be also provided by the socket.

The sockets are selected from at least one of: large and small USB sockets; iPod (registered trade mark) sockets, MP3 sockets, digital camera sockets, mobile telephone sockets and hard disk drives. A wireless module such as a Bluetooth or Wi-Fi unit may be connected to the socket to allow the portable device to communicate with the portable computer, for example for data transfer.

In a first preferred embodiment, the casing comprises a base and a detachable cover, the cover including one or more apertures defining sockets for portable devices; the base including one or more detachable or integral connectors mounted on mountings so that a device inserted into a socket may be connected via a detachable connector to the power supply, wireless transceiver or other device. In a first embodiment the connector may be detachable to allow an alternative connector to be used. Alternatively the connector may be integral with the adaptor.

Preferably, the mounting includes a seat for the connector arranged to secure the connector in an appropriate orientation, for example, facing upwardly, for engagement with a device inserted into the socket.

According to a second aspect of the present invention, a detachable connector for a portable device power supply includes a housing and a power supply connector extending in a first direction from the housing. A device connector extends from the housing parallel to the first direction and in an opposite direction. A power supply circuit is located within the housing between the power supply connector and the device connector and is arranged to control the power supply to the device connector.

The connectors are preferably USB connectors.

Preferably, the circuit comprises a printed circuit board. The printed circuit board may carry components selected from a voltage divider, a circuit limiter, a voltage limiter and a smoothing circuit. The voltage divider, circuit limiter or voltage limiter may be programmable to sense the model of the portable device and to set the voltage and/or current appropriately.

The printed circuit may include a current source to provide a constant current at various voltages.

Preferably the printed circuit comprises a printed circuit board extending perpendicular to the connectors within the housing. Alternatively, the circuit may comprise a printed circuit board extending parallel between the connectors within the housing.

The detachable connector may comprise a housing and a device connector extending from the housing in a first direction and a power supply and/or data connector extending from the housing in a second direction. The device connector is configured to connect to a device and the power supply and/or data connector is configured to connect to the power supply and/or to a data transmission circuit.

Preferably the first direction is opposite to the second direction.

In a first embodiment the device connector and power connector are coaxial so that the housing extends linearly between the connectors.

In a second, preferred, embodiment the device connector and power connector are parallel, arranged side-by-side in a stacked or folded arrangement. In such a stacked or folded arrangement the length of the housing and consequently of the detachable connector are reduced. This permits reduction in the height of the adapter when mounted upright. Furthermore the stacked or folded arrangement of the housing may provide an abutment, for example a ledge or rebate for secure engagement with the casing. In such an embodiment the printed circuit board may be perpendicular to the connectors.

In a first preferred aspect of the invention the casing includes an upwardly facing socket located at or adjacent an edge of the casing. The socket may include locking means for receiving and securely engaging a portable device connected to the socket for charging. Alternatively the detachable connector may be engaged by the locking means. The locking means may comprise a spring latch or a deformable resilient member dimensioned to provide a press fit engagement at the lower edge of a portable device. A quick release button may be provided to release the latch or to open the deformable member.

The casing may be rectangular in plan view having longer and shorter sides, the socket being located at an upper edge of a shorter side. In this arrangement a mobile phone or other device may be engaged with the control panel facing outwardly from the shorter edge so that the long sides of the casing extend rearwardly to provide a secure support resistant to toppling backwards when the key pad of the phone is actuated.

The upper surface of the casing may include a rebate adapted to abut and support the device or a detachable or an integral connector. The rebate may comprise side and rear surfaces dimensioned to snugly fit the connector supporting the connector against movement as the portable device is used or as it is engaged or disengaged from the socket.

The stacked or folded configuration of the detachable connector may be arranged to provide a right angled shoulder or other downward facing seat portion adapted to form a close fit with a correspondingly shaped corner or other upwardly facing edge or shoulder portion of the casing and rebate. In preferred embodiments of this invention the casing has a single socket.

In another aspect of the invention, the cover comprises inner and outer portions defining one or more channels between the portions for engagement with corresponding formations of the base. The formations may comprise projections or flanges extending outwardly of the base.

In this arrangement the base may comprise runners extending transversely with respect to the sockets, the cover being arranged to be slidable on the runners between a closed position ready for use and an open position in which the connectors may be removed from the seats for replacement to accommodate different portable devices.

Alternatively, the cover and base may be hinged, having a locking member or clasp which may be released to open the device for replacement of the connectors.

An adapter in accordance with the present invention confers several advantages. A single adapter may be used to power a lap-top or other portable computer and a range of portable devices, avoiding the need to carry a range of different power supplies. In addition, the need for more than one mains adapter is avoided when travelling because only a single power supply is necessary.

In further preferred embodiments, the detachable connectors may be selected to suit the devices carried by the user. For example, a connector suitable for the user's mobile phone may be selected from the large number of connectors required to connect all commonly available phones.

The connector may include a circuit adapted to adjust or control the power supply to the mobile device. The circuit may be optimised to meet the unique power requirements of a particular model of mobile device.

A printed circuit board (PCB) may include a circuit with a programmable or non-programmable voltage divider, current limiter, voltage limiter or more than one of these devices. The circuit may be adapted to detect the manufacturer and model of the mobile phone or other portable device and may be further programmed to set the voltage and/or current appropriately to optimise the performance of the device. A current source may provide a constant current at various voltages. A filter may be provided to remove ripples from the voltage supply.

The PCB may be mounted perpendicularly of the connectors in the housing. This provides a shorter structure, particularly in a stacked housing arrangement.

Alternatively, the PCB may be mounted parallel to the connectors in the housing, for example between the connectors. This provides a slimmer structure.

The device connector is preferably configured to connect to the particular device for which the power supply is optimised.

The adapter may function as an electronic device docking station and may include a wireless communication module, arranged to transfer data between the portable device and a notebook or other portable computer connected to the power supply. The wireless module may comprise a wireless transceiver connected to the circuit board of the adapter. The connector may function as a bridge between the device and the wireless transceiver connected to the circuit board.

A kit may be provided comprising the casing and a selection of connectors.

### BRIEF DESCRIPTION OF THE DRAWINGS

The invention is further described by way of example, but not in any limitative sense, with reference to the accompanying drawings, of which:

FIG. 1 shows an adapter in accordance with the present invention;

FIG. 2 is a cross-sectional view through the adapter;

FIG. 3 shows the upper casing of the adapter;

FIG. 4 shows an array of connectors for use with the adapter;

FIG. 5 shows a further connector;

FIG. 6 shows a further adapter in accordance with the invention;

FIG. 7 shows a further adapter in use with a mobile phone and laptop;

FIG. 8 shows a further embodiment of the invention;

FIG. 9 shows a connector in accordance with a further embodiment; and

FIG. 10 shows a connector in accordance with a further embodiment.

### DETAILED DESCRIPTION OF PREFERRED EMBODIMENT

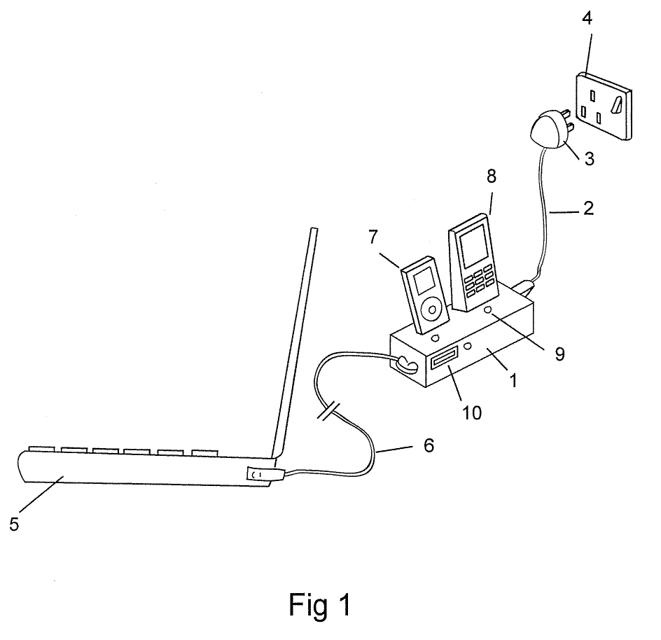

FIG. 1 shows an adapter in accordance with this invention. The adapter (1) has a mains supply lead (2) and mains plug (3) for connection to a wall socket (4). A lap-top or other portable computer (5) is connected by a power supply lead (6) in the conventional manner.

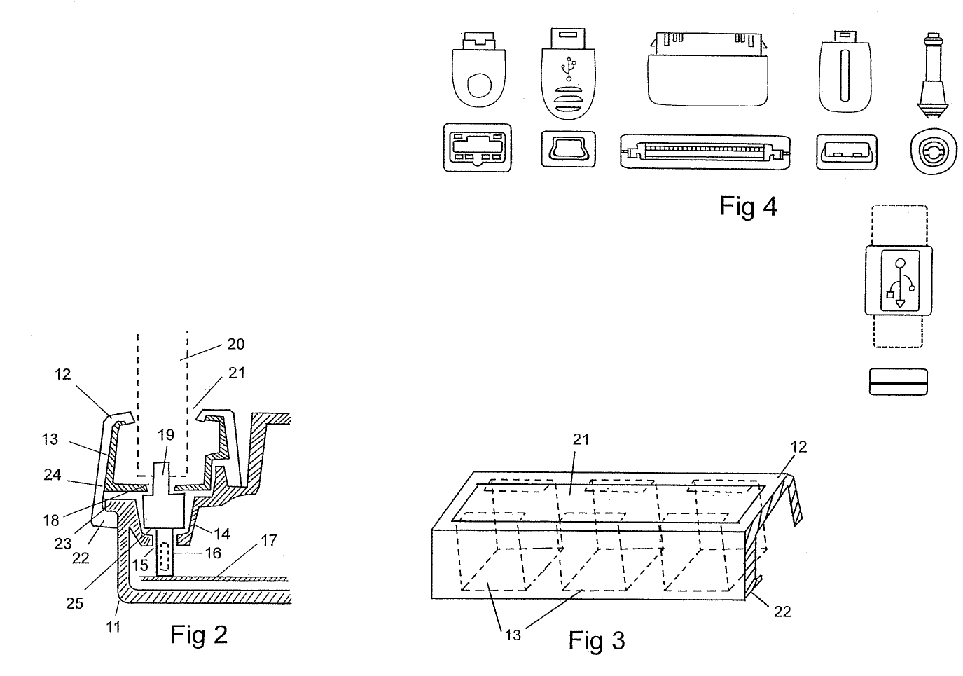

An MP3 player (7) and mobile phone (8) are received in sockets within the upper casing of the adapter (1) and are engaged with detachable connectors (25) as shown in FIG. 2 to enable charging directly whether or not lap-top (5) is connected to the portable computer power supply cable for simultaneous charging. LED displays (9) indicate the extent of charging of the portable electric devices (7, 8). In the illustrated embodiment, the adapter has two sockets to accommodate two portable devices. In alternative embodiments, three or more sockets may be provided. Additionally a laterally facing USB port (10) may be provided to receive one or more additional devices.

FIG. 2 is a cross-sectional view through part of an adapter in accordance with this invention. A casing (11) is engaged with a cover comprising an outer cover (12) and inner cover (13). The inner cover (13) may be formed of metal or rigid polymeric material in order to provide a resilient structure. The casing (11) includes one or more seats or depressions (14) each having an aperture (15) through which a power connector and/or data connector (16) of a connector (25) may be received to engage a contact of a power PCB circuit (17). The inner cover (13) has a channel shaped configuration with an aperture (18) adapted to receive the device connector (19) of the detachable connector (25). A portable electric device (20), for example an MP3 player or mobile telephone, is inserted in a downward direction into the socket (21) and engages the device connector (19) and abuts the inner surface of the lower casing (13), which provides secure support for the device (20). The outer cover (12) has an inwardly facing flange (22) which co-operates with the lower surface (24) of the inner casing to define a guideway to receive a runner (23) of the lower casing (11).

In the arrangement as shown in FIG. 3, three inner covers (13) are received within the outer cover (12) to define three sockets to receive three portable devices. The assembly shown in FIG. 3 may be inserted onto the lower base by sliding transversely.

A selection of connectors for various portable electrical devices are shown in plan view and side elevation view in FIG. 4. These comprise a telephone connector, USB connector, MP3 player connector, telephone jack or a large USB connector.

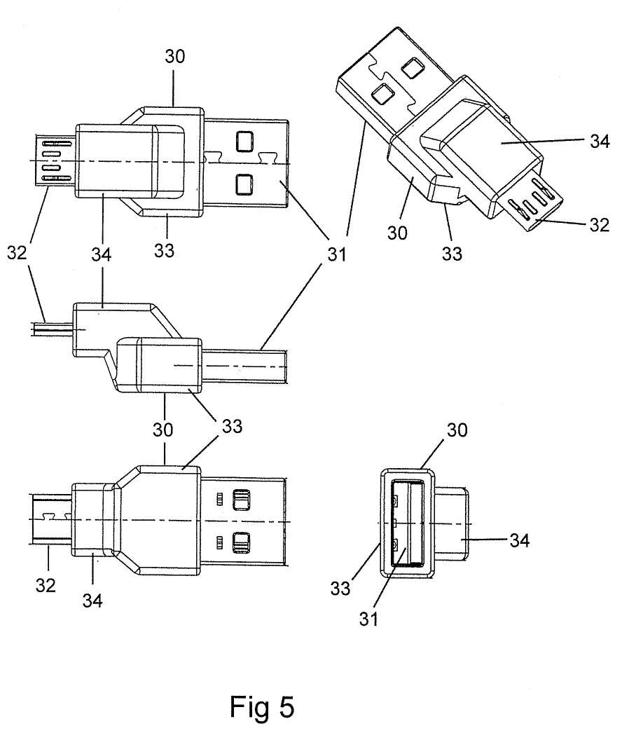

FIG. 5 shows various views of a detachable connector in accordance with this invention.

A housing (30) has a male USB connector (31), being the power connector and/or data connector, extending in a first direction and a device connector (32) extending in an opposite direction. The detachable device connector is selected to engage the power connection socket of a portable electric device (not shown) such as a mobile phone, MP3 player, iPod, digital camera, wireless hard drive, wireless speaker, other wireless devices or wireless transceiver.

The housing is divided into first (33) and second (34) portions having parallel axes offset in side-by-side stacked juxtapositions. In this embodiment the overall length of the connector is shorter than if the USB connector and device connector are arranged co-axially. The stacked arrangement allows the housing to incorporate a rebate, ledge or other abutment configured to engage a complementary formation of the casing, particularly a corner between the rebate and top surface of the casing.

In a preferred embodiment a kit comprising power supply and/or data connection and a selection of different detachable connectors is provided, the detachable connectors having device connectors selected to accommodate commonly available electric devices.

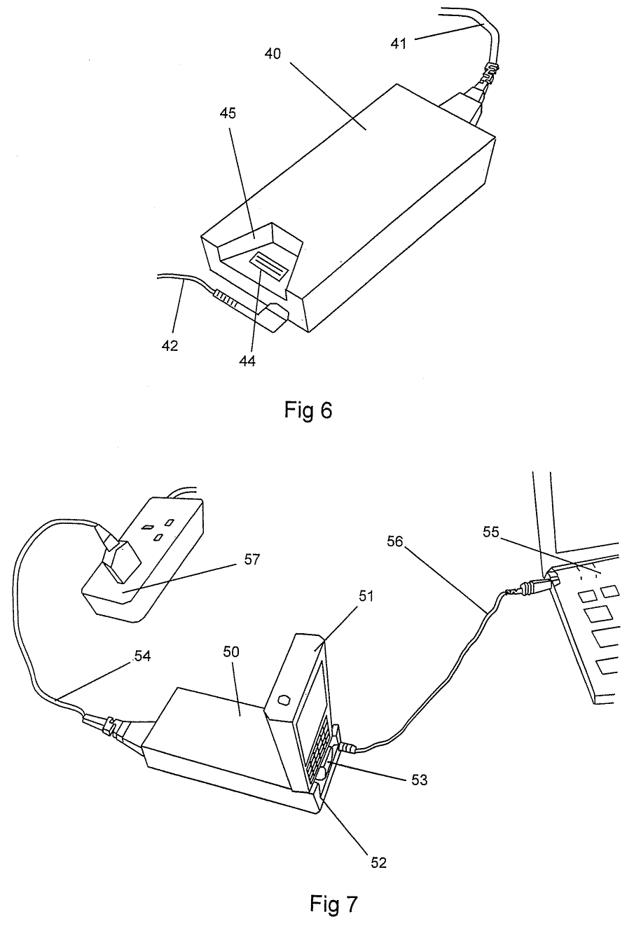

FIG. 6 illustrates an alternative adapter.

A casing (40) is connected to a power supply cable (41) and a power outlet cable (42) for connection to a laptop (not shown).

An upwardly facing socket (45) is formed in the edge of the short side of the rectangular casing. An upwardly facing connector (44) located in the lower upwardly facing surface of the socket (45) is arranged to receive a portable device (not shown) inserted in use into the socket (45). Alternatively a detachable connector as shown in FIG. 5 may be inserted into the connector (44), the body of the detachable connector including a ledge or rebate dimensioned to be engaged and to be supported by the vertical wall of the socket (45) and upper surface of the casing, preventing movement of the detachable connector in use.

FIG. 7 illustrates an embodiment similar to that of FIG. 6 wherein the casing (50) is secured to a mobile phone (51) mounted in the socket (52) by means of a clip (53). A power cable (54) connected to a power supply (57) supplies power to the device while an outlet (56) connected to a laptop powers the laptop in conventional manner. The mobile telephone (51) mounted on a narrow edge of the rectangular casing (50) so that the casing (50) supports the phone against toppling over rearwardly in use.

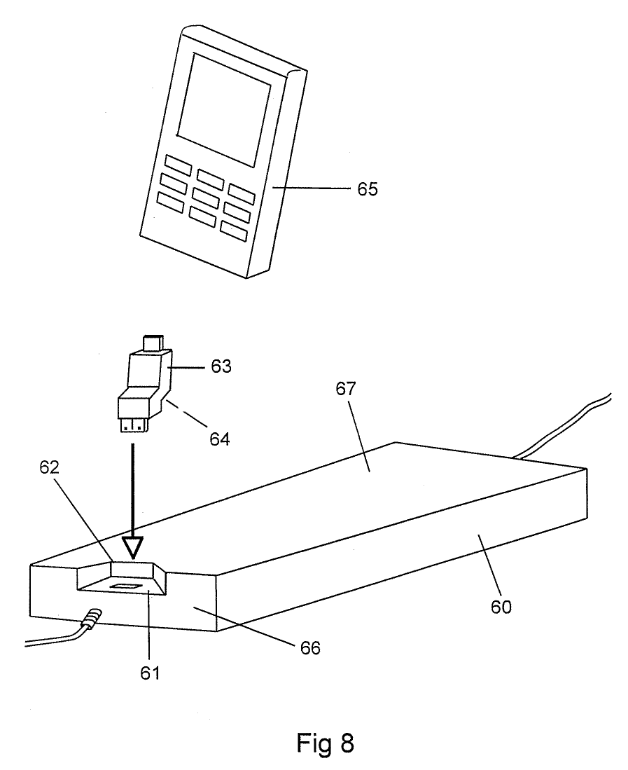

FIG. 8 illustrates an alternative embodiment wherein the housing (60) includes a stepped rebate (61) forming a socket in the narrow edge (66) of the casing (60). The rebate (61) forms a ledge or shoulder (62) in conjunction with the upper surface of the casing (60). A connector (63) received in the rebate (61) has a downwardly facing seat portion (64) to engage the upwardly facing ledge or shoulder (62) forming a secure seating for the connector. A mobile phone or other device (65) may be located upon the connector (63) as previously described. In this arrangement the connector (63) is securely mounted upon the ledge or shoulder (62) of the casing to form a secure support so that pressure on the connector and mobile device (65) does not damage the connector or socket to which it is engaged.

A plurality of connectors may be used in turn to allow connection with different mobile devices, with the engagement of the connectors and housing forming a snug fit to prevent damage to the connector in use.

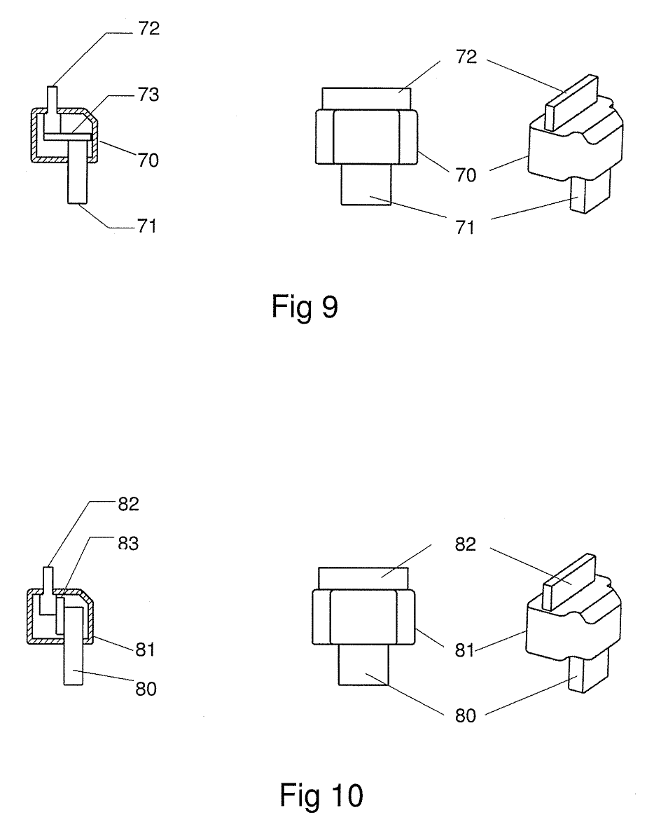

FIG. 9 shows an alternative detachable connector having a housing (70) with a power supply and/or data connector (71), for example a USB connector, extending downwardly for connection to a corresponding USB socket in the adapter housing. A device connector (72), for example a USB connector or a unique connector adapted for a particular portable device, extends upwardly from the housing (70) parallel to the power supply connector (71) but offset therefrom. The power and/or data connector is preferably a USB connector. A printed circuit board (73) carries a power supply circuit. A voltage divider with a programmable circuit serves to detect the manufacturer and model of a portable phone or other device and sets the voltage and/or current appropriately to suit the requirements of the device. A filter to remove ripples from the voltage supply is also provided.

FIG. 10 illustrates a further embodiment in which a power supply and/or data connector (80) extends downwardly from housing (81) parallel and offset to a device connector (82) which extends upwardly from the housing (81). A printed circuit board (83) is arranged parallel to the axes of and between the connectors (80, 82) as shown.

The invention claimed is:

1. A portable power supply adapter comprising:
a casing;
a mains power supply cable extending from the casing for connection to a mains power supply;
a portable computer power supply cable extending from the casing for connection to a portable computer;
the casing including power supply circuitry;
the casing having an upwardly facing surface, the surface including one or more sockets, the sockets being each adapted to receive a portable electric device and arranged so that the portable electric device may be charged from the mains power supply directly whether or not a portable computer is connected to the portable computer power supply cable for charging.

2. The adapter of claim 1, wherein the sockets are selected from one or more of: USB sockets; MP3 player sockets, digital camera sockets, mobile telephone sockets, wireless hard drive sockets, wireless speakers sockets, other wireless device sockets or wireless transceiver sockets.

3. The adapter of claim 2, wherein the casing comprises a base and detachable cover, the cover including one or more apertures defining sockets for portable devices; the base including at least one detachable connector mounted on one or more mountings so that a device inserted into a socket may be connected via the detachable connector to one of a power supply and a data supply.

4. The adapter of claim 3, including a seat for the detachable connector arranged to secure the connector facing upwardly.

5. The adapter of claim 4, wherein the detachable connector may be removed from the seat for replacement with a second detachable connector to accommodate a different portable device.

6. The adapter of claim 1, wherein the casing includes an upwardly facing socket located at or adjacent an upper edge of the casing.

7. The adapter of claim 1, wherein the sockets include locking means for receiving and securely engaging the portable electric device.

8. The adapter of claim 1, wherein the casing includes a rabbet adapted to abut and support a connector connected to the socket.

9. The adapter of claim 3, wherein the cover comprises inner and outer portions defining one or more channels between the portions for engagement with corresponding formations of the base; and wherein the base comprises runners extending transversely with respect to the sockets, the cover being arranged to be slidable on the runners between a closed position ready for use and an open position in which the connectors may be removed from the seats for replacement to accommodate different portable devices.

10. The adapter of claim 3, wherein the detachable connector comprises a housing and a device connector extending in a first direction and one of a power connector and a data connector extending in a second direction parallel and opposite to the first direction.

11. The adapter of claim 3, wherein the device connector and power connector and/or data connector are disposed in side-by-side juxtaposition.

12. The adapter of claim 3, wherein the connector includes a rabbet for connection to a corner of the casing.

13. The adapter of claim 1 wherein the power supply circuitry includes a wireless module for data transfer.

14. The adapter of claim 2, wherein the casing comprises a base and integral cover, the cover including one or more apertures defining sockets for portable devices; the base including at least one integral connector mounted on one or more mountings so that a device inserted into a socket may be connected via the integral connector to one of a power supply and a data supply.

15. The adapter of claim 14, wherein the integral connector comprises a housing and a device connector extending in a first direction and one of a power connector and a data connector extending in a second direction parallel and opposite to the first direction.

16. A detachable connector for a portable device power supply adapter comprising;
a housing;
at least one of a power supply and a data connector extending in a first direction from the housing;
a device connector extending from the housing parallel to the first direction in an opposite direction; and
a power supply circuit located within the housing between the power supply connector and the device connector and arranged to control the power supply to the device connector.
